(19) United States
(12) Patent Application Publication
(10) Pub. No.: US 2013/0175982 A1
(43) Pub. Date: Jul. 11, 2013

(54) Rechargeable Energy Storage Apparatus

(71) Applicants: Ross E. Teggatz, McKinney, TX (US); Wayne T. Chen, Plano, TX (US); Amer Atrash, Richardson, TX (US)

(72) Inventors: Ross E. Teggatz, McKinney, TX (US); Wayne T. Chen, Plano, TX (US); Amer Atrash, Richardson, TX (US)

(73) Assignee: Triune IP LLC, Richardson, TX (US)

(21) Appl. No.: 13/410,002

(22) Filed: Mar. 1, 2012

Related U.S. Application Data
(60) Provisional application No. 61/448,635, filed on Mar. 2, 2011.

(51) Int. Cl. H02J 7/02

(52) U.S. Cl. CPC H02J 7/025
USPC 320/108

(57) ABSTRACT

Rechargeable energy storage apparatus is disclosed in which the form factors of batteries and power packs are emulated by apparatus of the invention. Preferred embodiments of the invention provide energy storage capabilities equal or superior to those of conventional batteries or power packs. The rechargeable energy storage apparatus also provides wireless charging capabilities and data functionality.

### PRIORITY ENTITLEMENT

This application is entitled to priority based on Provisional Patent Application Ser. No. 61/448,635 filed on Mar. 2, 2011, which is incorporated herein for all purposes by this reference. This application and the Provisional Patent Application have at least one common inventor.

### TECHNICAL FIELD

The invention relates to portable electrical power apparatus. More particularly, the invention relates to portable energy storage apparatus for use with inductively coupled wireless power transfer systems. In preferred embodiments, the invention relates to the more efficient utilization of energy resources.

### BACKGROUND

Portable electronics apparatus commonly requires a portable power storage device such as a battery or battery pack to supply power for operation. When the batteries are discharged, they must be recharged again in order for the apparatus to resume operation. Wireless power transfer presents a convenient way to charge batteries without the need for a wired power connection. Existing wireless power transmission systems utilize coupled inductor coils to transfer power from a charging coil to a receiving coil. Some of the systems known in the art also transmit data as well as power. Typically such systems use a dedicated power transmission coil, or set of coils on a primary charger side. One or more dedicated receiving coils are provided in association with each battery or battery pack on a secondary side. Among the problems with such systems is the requirement of providing compatible batteries for use with apparatus designed to accept standard batteries. Much of the electronic apparatus in existence is designed to use common batteries having standard form factors, such as AAA, . . . D, and PP3 sizes, for example.

Due to these and other problems and potential problems, improved rechargeable energy storage apparatus for use with coupled inductor charging systems would be useful and advantageous contributions to the arts.

In carrying out the principles of the present invention, in accordance with preferred embodiments, the invention provides advances in the arts with novel apparatus directed to the transfer of power to power packs using inductive couplings. In preferred embodiments, the apparatus includes capabilities for power transfer, and for data transfer more than sufficient to manage power functions.

According to aspects of the invention, examples of preferred embodiments include rechargeable energy storage apparatus having one or more storage element, one or more secondary coil, and control circuitry.

According to aspects of the invention, examples of preferred embodiments include rechargeable energy storage apparatus having energy storage elements removable for charging.

According to aspects of the invention, examples of preferred embodiments of rechargeable energy storage apparatus include charging apparatus and energy storage element(s) integrated with a housing.

According to another aspect of the invention, preferred embodiments of rechargeable energy storage apparatus include power packs having a wireless interface configured for transmitting and receiving data.

According to another aspect of the invention, preferred embodiments of rechargeable energy storage apparatus include power packs having a battery and/or capacitor power storage unit.

The invention has advantages including but not limited to one or more of, improved coupled coil charging system efficiency, convenience, compatibility, and reduced costs. These and other potential advantageous, features, and benefits of the present invention can be understood by one skilled in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a simplified perspective view of a preferred embodiment of rechargeable energy storage apparatus according to the invention;

FIG. 2 is a perspective view of an example of an alternative preferred embodiment of rechargeable energy storage apparatus according to the invention;

FIG. 3 is a perspective view illustrating an example of an alternative preferred embodiment of rechargeable energy storage apparatus according to the invention;

FIG. 4 is a perspective view illustrating an example of an alternative preferred embodiment of rechargeable energy storage apparatus according to the invention; and

FIG. 5 is a perspective view illustrating an example of an alternative preferred embodiment of rechargeable energy storage apparatus according to the invention.

References in the detailed description correspond to like references in the various drawings unless otherwise noted. Descriptive and directional terms used in the written description such as right, left, back, top, bottom, upper, side, et cetera, refer to the drawings themselves as laid out on the paper and not to physical limitations of the invention unless specifically noted. The drawings are not to scale, and some features of embodiments shown and discussed are simplified or amplified for illustrating principles and features as well as advantages of the invention.

### DESCRIPTION OF PREFERRED EMBODIMENTS

The present patent application is related to U.S. patent application Ser. Nos. 13/309,423, 13/045,493, and 13/355,416, each of which share at least one common inventor with the present application and has a common assignee. Said related applications are hereby incorporated herein for all purposes by this reference.

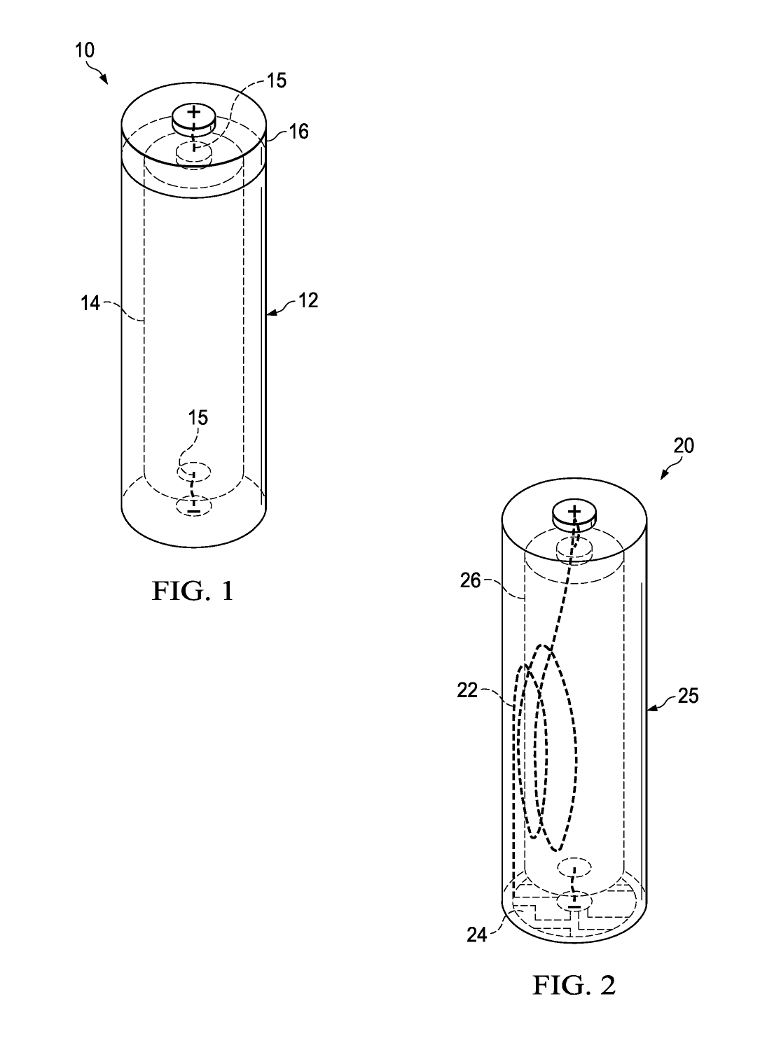

Initially referring primarily to FIG. 1, an exemplary embodiment of rechargeable energy storage apparatus 10 is shown. A housing 12 is configured to provide the same form factor as a standard battery type. In this example, it is an “AA” sized battery generally known in the art. A power storage element 14 is fitted within the housing 12, in this example, a rechargeable “AAA” sized battery 14 is shown. It should be understood that the power storage element 14 may be a battery, storage capacitor, or an array or combination of batteries and/or capacitors. In order to realize the advantages of the invention, rechargeable power storage elements are preferred. For example, a rechargeable battery of any chemistry type or shape may be used, such as Li-Ion, NiMH, thin-film batteries, round batteries, flat pack batteries, block shaped, batteries, etc., as well as arrays of batteries. Additionally, or alternatively, capacitors, super capacitors, and/or arrays of the same may be used. Although a familiar AA-shaped housing 12 is shown by way of example, the housing 12 may be cylindrical, disc-shaped, flat, block shaped, and may be implemented in any shape suitable to emulate a standard or proprietary battery or power pack as needed in order to fit a particular application. Many variations are possible within the scope of the invention. For systems that require multiple battery packs, the rechargeable energy storage apparatus, e.g., as shown in the Figures, allows for ease of swapping out a power storage element, or elements, in a system. This may be used advantageously for supplemental power, or for swapping out depleted power sources for newer/recharged power sources.

Also shown in FIG. 1, access to the power storage element 14 within the housing 12 may be provided by suitable means, such as for example, a movable or removable portion 16 of the housing 12. Thus, the power storage element 14, in this case the battery, may be removed for recharging and replaced. It should be noted that contacts consistent with the selected form factor, e.g., positive “+” and negative “−” terminals as for an AA battery are provided on the exterior of the housing 12, and are electrically connected with the power storage element 14 using suitable conductors 17.

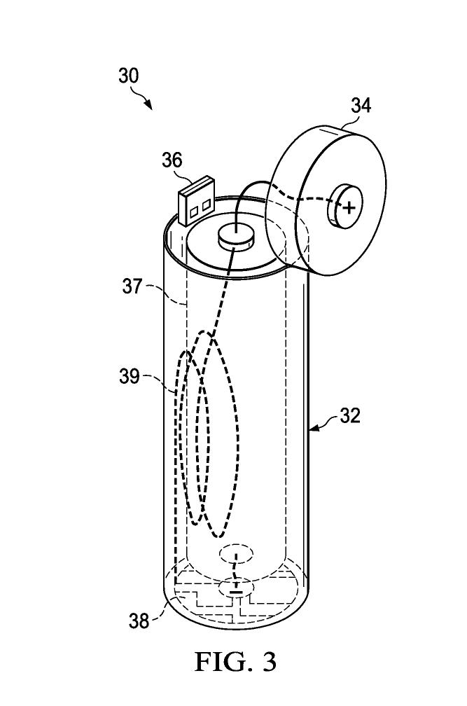

FIG. 2 illustrates an example of a preferred embodiment of rechargeable energy storage apparatus 20 in which a coil 22 and electronic circuitry 24 for wireless charging are included, preferably integrated with the housing 25. In this configuration, the power storage element 26 within the apparatus 20 need not be removed from the housing 25 for recharging. Instead, using a rechargeable power storage element 26 coupled to the coil 22 and linked with suitable control circuitry 24, the entire apparatus 20 may be placed on a wireless charging station (not part of the invention) designed to charge coil-equipped batteries or other power storage elements, in order to be recharged. The coil, e.g., 22, may be serpentine and/or wrapped around the housing 25 in a cylindrical, semi-cylindrical, “taco-like” or “enchilada-like” configuration, or may be coiled around the long axis of the housing 25 or may be disc or other planar shape. It has been found that planar coils that are then conformed to the shape of the housing provide superior wireless coupling efficiency in comparison with coiled wires having the housing at their core. The wireless power transfer mechanism used in association with the rechargeable energy storage apparatus may utilize wireless inductive coupling, capacitive coupling, or RF coupling, without departure from the invention. Preferably, the power control circuitry 24 includes functionality sufficient to control the charging of the power storage element(s) 26 by communicating with an associated charger and/or charging system. Additional data transfer capabilities may also be included in the control circuitry 24, including functionality for data transmittal, receipt, and/or storage.

FIG. 3 illustrates an example of another embodiment of rechargeable energy storage apparatus 30. The housing 32 includes a cover 34, in this exemplary implementation a hatch 34 hinged for access to an electrical connector 36 within the housing 32. For example, the connector 36 may be a USB-style connector 36 as shown in order to provide connectability with cell phones/PDAs/other portable electronics for the purposes of transferring power and/or data. Electronic circuitry 38 operable with the connector 36 is provided, such as a power transceiver, in the case as in this example wherein the apparatus 30 is designed to both receive and transmit power. In the case of a USB-type connector 36, the electronics 38 includes a configuration to boost the voltage of an energy storage element 37, such as a single cell NiMH battery, to 5V for USB-compatible use. In the case of a USB or other connector 36 that can serve to transfer both power and data, data storage circuitry may also be included in the circuitry 38 within the housing 32. The connector 36 may also have an extension cord # stored in the housing 32 in order to allow for more access and placement flexibility for the connector 36. A coil 39, or coils within the housing 32 may also be used for wireless power and/or wireless data transfer. Additional electronics may be included in the circuitry 38 in order to provide data transfer functionality. Such data may be used for other electronic systems within the housing 32, or to communicate with other housings or devices within the proximity of the housing 32.

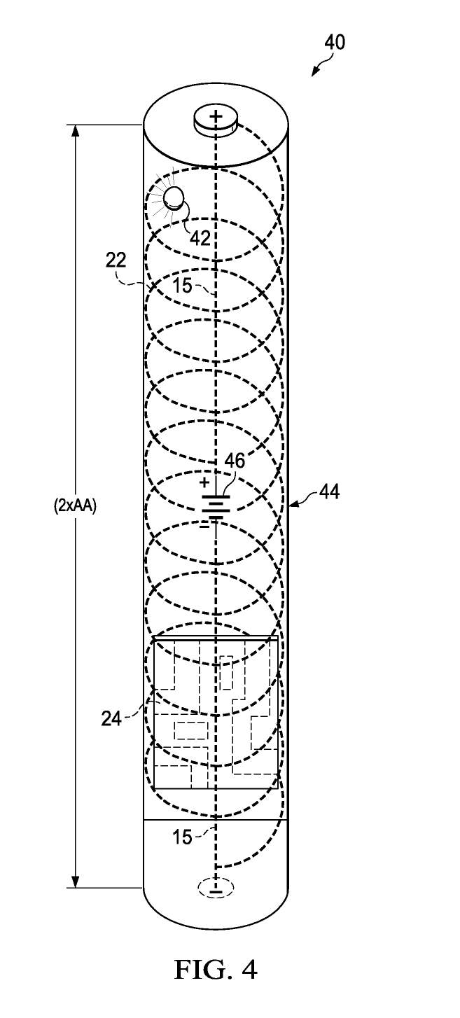

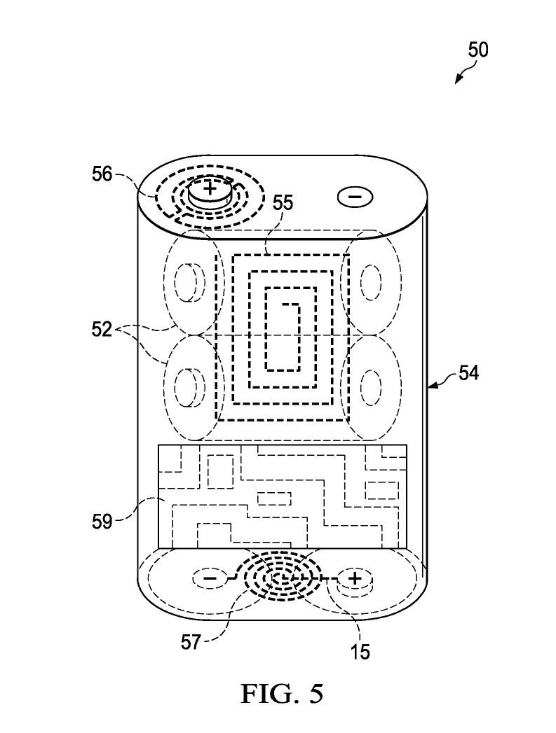

Further examples of preferred embodiments of rechargeable energy storage apparatus are shown in FIGS. 4 and 5. A battery charge indicator 42 may be included on the housing 44 of the apparatus 40 to indicate charge remaining on the energy storage element(s) 46. Moreover, as shown in the apparatus of FIGS. 4 and 5 (40, 50, respectively), the apparatus may be configured to emulate the form factor of conventional batteries or power packs in various forms, such as those of proprietary batteries, or power packs containing multiple batteries, e.g., either in a tandem 40, or dual 50 arrangement. Typically, batteries or capacitors may have metallic outer cases. It has been determined that the separation between coils and other metallic components in the rechargeable energy storage apparatus of the invention provides advantages such as reducing inductive heating and improving efficiency. If separation between the coil(s) and housing and/or storage element casings are maintained, the housing or storage element casings may be made of metal. Alternatively, the housing and/or storage element casings may be made of non-metallic material. In other potential variations of the invention, separation material may be interposed between the coil(s) and other metallic components. For example, a ferrite shield may be used to improve magnetic coupling and reduce the effects of heating.

Many variations are possible within the scope of the invention. In preferred embodiments, the apparatus of the invention preferably includes wireless data transmission functions as well as wireless power transmission capabilities. The wireless interface coil is preferably connected with additional circuitry designed for transmitting and receiving data signals as well as power signals. The rechargeable energy storage apparatus of the invention typically resides in electronic apparatus of various kinds For example, communication, computer, imaging, or other portable apparatus, to cite a few examples, may be equipped with rechargeable energy storage apparatus according to the invention. In operation, the apparatus is positioned within a host system such that it may be placed in physical proximity with wireless chargers and/or data transceivers, having the necessary components to complete a wireless interface such that the coils are in communication with one another for the exchange of power and/or data. For purposes of clarity, detailed descriptions of functions, components, and systems familiar to those skilled in the applicable arts are not included. The methods and apparatus of the invention provide one or more advantages including but not limited to, data transfer capabilities, managed power transfer capabilities, and enhanced energy utilization and conservation attributes. While the invention has been described with reference to certain illustrative embodiments, those described herein are not intended to be construed in a limiting sense. For example, variations or combinations of steps or materials in the embodiments shown and described may be used in particular cases without departure from the invention. Various modifications and combinations of the illustrative embodiments as well as other advantages and embodiments of the invention will be apparent to persons skilled in the arts upon reference to the drawings, description, and claims.

We claim:

1. Rechargeable energy storage apparatus comprising:
a housing having a form factor compatible with a portable electronic system;
an energy storage element contained within the housing and having electrical connections compatible with the housing;
a wireless interface coil operably coupled to the energy storage element for transmitting charging current received from an external source to the energy storage element; and
control circuitry operably coupled to the energy storage element for managing the charge thereof.

2. Rechargeable energy storage apparatus according to claim 1 further comprising control circuitry having data management functionality.

3. Rechargeable energy storage apparatus according to claim 1 further comprising control circuitry having data storage functionality.

4. Rechargeable energy storage apparatus according to claim 1 wherein the wireless interface coil further comprises data transfer functionality.

5. Rechargeable energy storage apparatus according to claim 1 wherein the energy storage element further comprises one or more batteries.

6. Rechargeable energy storage apparatus according to claim 1 wherein the energy storage element further comprises one or more capacitors.

7. Rechargeable energy storage apparatus according to claim 1 further comprising a data connector operably coupled to the control circuitry.

8. Rechargeable energy storage apparatus according to claim 1 wherein the housing is configured to emulate a standard battery form factor.

9. Rechargeable energy storage apparatus according to claim 1 wherein the housing is configured to emulate a standard multi-battery form factor.

10. Rechargeable energy storage apparatus according to claim 1 further comprising control circuitry having data management functionality.

11. Rechargeable energy storage apparatus according to claim 1 further comprising ferrite shielding interposed between an energy storage element and a coil.

12. Rechargeable energy storage apparatus according to claim 1 wherein the energy storage element further comprises a non-metallic casing.

13. Rechargeable energy storage apparatus according to claim 1 wherein the housing further comprises a non-metallic material.

14. Rechargeable energy storage apparatus comprising:
a housing having a form factor compatible with a portable electronic system;
an energy storage element contained within the housing and having electrical connections compatible with the housing;
a first wireless interface coil operably coupled to the energy storage element for transmitting charging current received from an external source to the energy storage element;
control circuitry operably coupled to the energy storage element for managing the charge thereof; and
a second wireless interface coil operably coupled to the control circuitry for receiving data.

15. Rechargeable energy storage apparatus according to claim 14 wherein the second wireless interface coil and control circuitry are adapted for transmitting data.

16. Rechargeable energy storage apparatus according to claim 14 further comprising data storage operably coupled with the second wireless interface coil and control circuitry.

17. Rechargeable energy storage apparatus according to claim 14 further comprising a data connector operably coupled to the control circuitry.

18. Rechargeable energy storage apparatus according to claim 14 wherein the housing is configured to emulate a standard battery form factor.

19. Rechargeable energy storage apparatus according to claim 14 wherein the housing is configured to emulate a standard multi-battery form factor.

20. Rechargeable energy storage apparatus according to claim 14 further comprising ferrite shielding interposed between an energy storage element and a coil.

21. Rechargeable energy storage apparatus according to claim 14 wherein the energy storage element further comprises a non-metallic casing.

22. Rechargeable energy storage apparatus according to claim 14 wherein the housing further comprises a non-metallic material.
